(19) United States
(12) Patent Application Publication
(10) Pub. No.: US 2025/0264378 A1
(43) Pub. Date: Aug. 21, 2025

(54) SYSTEMS AND METHODS FOR PREDICTIVE MAINTENANCE OF EQUIPMENT

(71) Applicant: SAUDI ARABIAN OIL COMPANY, Dhahran (SA)

(72) Inventors: Mohammed AL-HAFITH, Udhailiyah (SA); Ahmed ALEISSA, Udhailiyah (SA); Abdullah AL-NAIM, Udhailiyah (SA); Marek ZIDEK, Udhailiyah (SA)

(73) Assignee: SAUDI ARABIAN OIL COMPANY, Dhahran (SA)

(21) Appl. No.: 18/583,443

(22) Filed: Feb. 21, 2024

(51) Int. Cl. G01M 99/00

(52) U.S. Cl. CPC G01M 99/005

(57) ABSTRACT

Systems and methods are disclosed relating to preventative maintenance. In an example, equipment data for equipment that can include data points relating to physical attributes of the equipment or environmental conditions for the equipment can be received. A machine learning (ML) model can be used to analyze the equipment data to determine whether the equipment needs maintenance. A correlator can be used to analyze the equipment data to determine whether the equipment data contains an anomaly indicative of a negative correlation between two more different attributes of the physical attributes and two or more different environmental conditions of the environmental conditions. A remedial action can be issued in response to the ML model determining that the equipment needs maintenance and/or the correlator determining that the equipment data contains the anomaly.

### FIELD OF THE DISCLOSURE

This disclosure relates generally to equipment maintenance, and more particularly, to systems and methods for predictive maintenance of equipment.

### BACKGROUND OF THE DISCLOSURE

Preventive maintenance for equipment refers to regular and routine maintenance activities carried out to keep equipment in good working condition and to prevent unexpected breakdowns and failures. Preventive maintenance is used to prolong a life of equipment, ensure its reliability, and improve its performance. To prevent failures, preventive maintenance uses a time-based or usage-based approach. For example, maintenance tasks might be scheduled every month or after every 100 hours of equipment operation. By contrast, predictive maintenance involves continuously monitoring a condition of equipment during operation to predict when maintenance should be performed.

### SUMMARY OF THE DISCLOSURE

Various details of the present disclosure are hereinafter summarized to provide a basic understanding. This summary is not an extensive overview of the disclosure and is neither intended to identify certain elements of the disclosure nor to delineate the scope thereof. Rather, the primary purpose of this summary is to present some concepts of the disclosure in a simplified form prior to the more detailed description that is presented hereinafter.

According to an embodiment, a method can include receiving equipment data for equipment comprising data points relating to physical attributes of the equipment or environmental conditions for the equipment, analyzing the equipment data using a machine learning (ML) model to determine whether the equipment needs maintenance, analyzing using a correlator the equipment data to determine whether the equipment data contains an anomaly indicative of a negative correlation between two more different attributes of the physical attributes and two or more different environmental conditions of the environmental conditions, and issuing a remedial action in response to the ML model determining that the equipment needs maintenance and/or the correlator determining that the equipment data contains the anomaly.

According to another embodiment, a system can include a predictive maintenance engine that can include a data aggregator configured to aggregate equipment data from one or more data sources to provide aggregated equipment data. The equipment data can include data points relating to physical attributes of the equipment or environmental conditions for the equipment. The predictive maintenance engine can further include a correlator configured to analyze the aggregated equipment data to determine whether the aggregated equipment data contains an anomaly indicative of a negative correlation between two more different attributes of the physical attributes and two or more different environmental conditions of the environmental conditions, an an analyzer comprising an ML model configured to analyze the aggregated equipment data to determine whether the equipment needs maintenance, and a remediator configured to issuing a remedial action in response to the ML model determining that the equipment needs maintenance and/or the correlator determining that the equipment data contains the anomaly.

In yet another embodiment, a system can include one or more computing platforms configured to receive equipment data for equipment comprising data points relating to physical attributes of the equipment or environmental conditions for the equipment, analyze the equipment data using an ML model to determine whether the equipment needs maintenance, analyze using a correlator the equipment data to determine whether the equipment data contains an anomaly indicative of a negative correlation between two more different attributes of the physical attributes and two or more different environmental conditions of the environmental conditions, and issue a remedial action in response to the ML model determining that the equipment needs maintenance and the correlator determining that the equipment data contains the anomaly.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is an example of a block diagram of a system with a predictive maintenance engine that can be used for predictive maintenance of equipment.

FIG. 2 is an example of a predictive maintenance system.

FIG. 3 is an example of a remote terminal unit (RTU).

FIG. 4 is an example of a facility configured with a heating, ventilation, and air condition

(HVAC) system and fire system that uses predictive maintenance according to one or more examples as disclosed herein.

FIG. 5 is an example of a method of predicting maintenance of equipment, such as the equipment.

FIG. 6 is an example of a computing environment that can be used to perform one or more methods according to an aspect of the present disclosure.

FIG. 7 is an example of a cloud computing environment that can be used to perform one or more methods according to an aspect of the present disclosure.

FIG. 8 is an example of a graphical user interface (GUI) that can be provided according to one or more examples as disclosed herein.

FIG. 9 is an example of aggregated equipment data.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Examples are disclosed herein relating to predictive maintenance. Existing monitoring system at communication sites does not detect abnormal parameters unless equipment is impacted and alarms are triggered. Moreover, existing monitoring systems do not provide operation logs and analysis, as well as do not support information technology (IT) sustainability as it is based on post failure notification where such method delays employee response time, maintenance engagement, and failure time resolution. In addition, extended failure resolution time and reoccurrence can impact equipment life cycle, which accelerates spare parts consumption. Machine learning is becoming a part of a company digital transformation program and has been mandated as part of an IT Artificial Intelligence operations (AIOps) program at some organizations to enable AI for communication facilities. Currently, there is no AI capability enabled across all IT communication sites (or facilities) to interact with real-data to allow capabilities of data correlation, anomaly detection, and advanced events/logs analysis for a purpose of predicting equipment failure, suggesting a required maintenance and auto remediation to help in improving proactive maintenance.

Systems and methods are disclosed herein that allows for predicting or detecting abnormal equipment conditions for predictive equipment maintenance. In some examples, a system can include sensors that can be used for data collection and utilize machine learning and correlation techniques to detect equipment issues that can impact operation of the equipment and/or facilities. For example, the system can be configured to correlate, remediate, report, and identify equipment or environmental conditions and recommend corrective actions. The system can be used to enhance equipment preventative maintenance by recommending appropriate preventative maintenance plans, which can extend equipment life and increases equipment availability. The system can be used to enhance an existing preventive maintenance platform through use of machine learning and correlation techniques to mitigate facilities equipment failures.

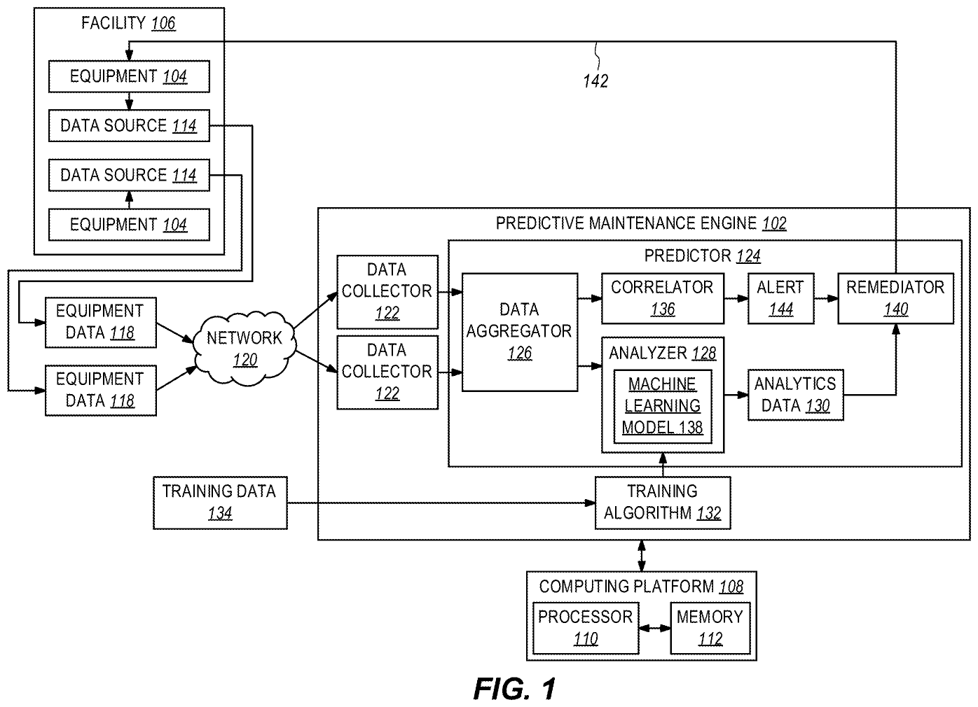

FIG. 1 is an example of a block diagram of a system with a predictive maintenance engine 102 that can be used for predictive maintenance of equipment 104 at a facility 106. In some examples, the equipment 104 is similar types of equipment, in other examples the equipment 104, as shown in FIG. 1, are different types of equipment. The system 100 can be implemented using one or more modules, shown in block form in the drawings. The one or more modules can be in software or hardware form, or a combination thereof. In some examples, the system 100 can be implemented as machine readable instructions for execution on one or more computing platforms 108 (referred to as a computing platform herein), as shown in FIG. 1. The computing platform 108 can include one or more computing devices selected from, for example, a desktop computer, a server, a controller, a blade, a mobile phone, a tablet, a laptop, a personal digital assistant (PDA), and the like. The computing platform 108 can include a processor 110 and a memory 112. By way of example, the memory 112 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 110 can be implemented, for example, as one or more processor cores. The memory 112 can store machine-readable instructions that can be retrieved and executed by the processor 110 to implement the system 100. Each of the processor 110 and the memory 112 can be implemented on a similar or a different computing platform. The computing platform 108 can be implemented in a cloud computing environment (for example, as disclosed herein) and thus on a cloud infrastructure. In such a situation, features of the computing platform 108 can be representative of a single instance of hardware or multiple instances of hardware executing across the multiple of instances (e.g., distributed) of hardware (e.g., computers, routers, memory, processors, or a combination thereof). Alternatively, the computing platform 108 can be implemented on a single dedicated server or workstation.

A facility as used herein can refer to a physical location or structure equipped for a particular purpose or activity. Thus, the facility can include a place where business and/or industrial activities occur. In some examples, the facility includes one or more rooms, such an information technology (IT) room. The facility can include a building, structure, machinery and/or equipment that can be needed for operation of an organization or for performing specific tasks. The facility can vary in size, complexity, and/or function, depending on the nature of the activities that such objects support. Example facilities can include, but not limited to, industrial facilities (e.g., manufacturing plants, factories, warehouse, processing unit), commercial facilities, healthcare facilities, educational facilities, public and government facilities, recreational facilities, transportation facilities, utility facilities, etc. In each of these facilities, sensors (data sources) can be implemented for various purposes, for example, monitoring equipment performance, ensuring safety, optimizing operations, or maintaining environmental conditions. A specific nature or a type of the facility (or a room of the facility) can determine types of data sources (e.g., sensors) that are used and a type of data that is collected for effective management and/or operation.

Equipment as used herein can refer to a tool, a machinery, a device, and other apparatus used for a specific purpose. Equipment can consist of one or more tangible assets that can be used to carry out specific tasks or functions within an operation or activity. Example equipment can include, but not limited to, manufacturing equipment (e.g., assembly line machinery, machining tools, etc.), office equipment (e.g., computers, printers, photocopiers, scanners, etc.), construction equipment (e.g., heavy machinery, power tools, etc.), medical equipment (e.g., diagnostic machines, surgical instruments, etc.), laboratory equipment (e.g., analytical instruments, chemical handling equipment, etc.), agricultural equipment (e.g., tractors, harvesters, irrigation systems, etc.), food service equipment (e.g., cooking appliances, refrigeration units, etc.), IT and networking equipment (e.g., servers, routers, data storage systems), fitness and sports equipment (e.g., gym machines, sports gears, etc.), and heating, ventilation, air conditioning (HVAC) equipment (e.g., furnaces, boilers, air handling units, exhaust fans, air conditions, ductless mini-split systems, heat pumps, thermostat and control systems, air filtration and purification systems, humidifiers, dehumidifiers, etc.), IT equipment (e.g., server rack, etc.) etc.

A data source as used herein can refer to any entity, device, sensor, or system that can provide data (e.g., raw data points, for example) relating to a physical attribute of the equipment and/or an environmental condition affecting the equipment for further processing and analysis, such as predictive maintenance. A data source according to the examples herein can be configured to gather (e.g., measure, record, readings, and/or receive) data points related to the physical attribute of the equipment or the environmental condition affecting the equipment, such as the equipment 104, as shown in FIG. 1. In the example of FIG. 1, data sources 114 are used to provide data points (e.g., values) relating to or describing a physical attribute of a respective one of the equipment 104, or environmental condition of the equipment 104. Example data sources can include, but not limited to, vibration sensors, temperature sensors, pressure sensors, acoustic sensors, electrical sensors, control systems (e.g., programmable logic controllers (PLCs), Supervisory Control and Data Acquisition (SCADA) systems, etc.), monitoring equipment (e.g., condition monitoring devices (e.g., specialized tools that assess a condition of machinery, such as thermal imagers or oil analysis equipment)), environment monitors (e.g., devices that can measure ambient condition, such as air quality meters, humidity sensors, ambient temperature sensors, etc.), information technology (IT) systems (e.g., networked software and/or hardware (e.g., Internet of Things (IoT) devices that can transmit data for analysis), data storage systems, etc.), human input (e.g., manual readings and logs, for example, in instance in which data is collected manually entered at the data source), etc.

Each data source 114 can provide equipment data 118, as shown in FIG. 1, which can be provided over a network 120 to the predictive maintenance engine 102. The equipment data 118 from each data source 114 can include one or more data points relating to a physical attribute (or parameter) of equipment or environmental condition of the equipment. A physical attribute refers to an inherent property or operational characteristic of the equipment. Example physical attributes can include, but not limited to, vibration, temperature, pressure, sound/acoustic emission, electrical properties, etc. An environment condition refers to an external factor surrounding an equipment that can impact the equipment, for example, a performance of the equipment, longevity, and/or safety. Example environmental conditions can include, but not limited to, ambient temperature, humidity, air quality, lighting conditions, vibration from surroundings, etc.

The predictive maintenance engine 102 can include data collectors 122 to collect and store in memory (e.g., the memory 112) the equipment data 118 over time for the equipment 104. The example of FIG. 1 illustrates data being collected from two or more equipment but in other examples more or less equipment can be used at the facility 106 and one or more data collectors can be used for each equipment (and/or environment in which the equipment is used). The predictive maintenance engine includes a predictor 124 that can be used to predict equipment failure (e.g., for the equipment 104, such as when the equipment will fail), provide a suggestion (e.g., one or more PM plans), and generate one or more remedial actions to initiate predictive maintenance.

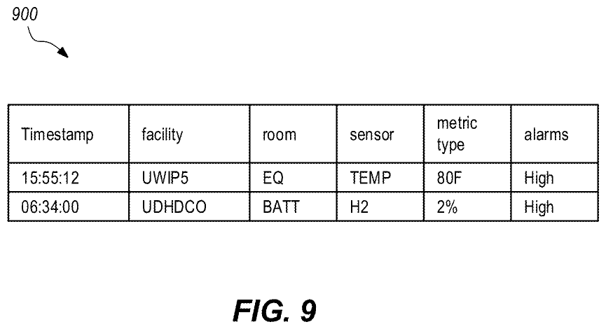

The predictor 124 includes a data aggregator 126. The data aggregator 126 can be used to aggregate the equipment data 118 from each of the equipment data 118. The equipment 104 can include data points relating to physical attributes of the equipment or environmental conditions for the equipment. For example, the data aggregator 126 can process the equipment data 118 into a common format, or defined format to provide aggregated equipment data. FIG. 9 is an example of aggregated equipment data 900 in the common format that can be provided by the data aggregator 126 based on the equipment data 118. For example, “alarms” in the aggregated equipment data 900 can indicate if a reading provided by a sensor (e.g., a temperature sensor and hydrogen sensor) was within a normal range or outside the normal range (indicated as “High” in the example of FIG. 9). As an example, each sensor triggered an alarm, as shown in FIG. 9. Each sensor can be associated with or used to monitor equipment, such as one of the equipment 108. With respect to the example of FIG. 9, the temperature sensor can be used to monitor the temperature of one of the equipment 108, or an environment in which the equipment 108 is located. The hydrogen sensor can be used to monitor a battery, which can correspond to one of the equipment 108.

The predictor 124 can include an analyzer 128. The analyzer 128 can include a machine learning model 138 that has been trained to determine whether the equipment 104 needs maintenance. The machine learning model 138 can in some instances predict when in time that the equipment 104 is likely to fail. The machine learning model 138 can in some instances identify one or more actions (e.g., PM actions) for the maintenance of the equipment 104. The analyzer 128 can provide analytics data 130 which can indicating whether the equipment 104 needs maintenance, when in time the equipment 104 is likely to fail, and the one or more actions for the maintenance of the equipment 104. The analytics data 130 can be provided by the analyzer 128 based on the aggregated data provided by the data aggregator 126. The machine learning model 138 can be trained by a training algorithm 132 based on training data 134. In a non-limiting examples, the training algorithm 132 can be configured to observe a current room temperature and required supplied air temperature with regard to required time to reach to a predefined set-point temperature. Any variance in those parameters or elements can be used as the training data 134 for training the machine learning model 138. For example, a supervised training algorithm can be used to train the machine learning model 138. The training data 134 can represents a variance between real-time data and predefined data (e.g., the difference between a room temperature, a set-point and a current room temperature). For instance, with regard to the example provided above, the training data 134 can characterize a lower air supplied temperature or a longer period of time for current room temperature to reach set-point temperature

The training data 134 can be selected based on system reading data trend upon failure. For instance, the training data 134 could be time taken for supplied air with specific temperature to influence room temperature to reach set-point temperature. Whenever a cooling compressor continuously works for over 8 hours, a failure happens in the air handling unit. The predictor 124 can include a correlator 136. The correlator 136 can implement a correlation technique or analysis of the aggregated equipment data. For example, the correlator 136 can process the aggregated data to examine or evaluate how metrics change over time. The correlator 136 can evaluate how a temperature reading (or measurement) changes or varies throughout a day or in relation to one or more specific events in some instances. The correlator 136 can assess if there are patterns in the aggregated data, for example, based on a location (e.g., facility and/or room, as identified in the example of FIG. 9). The correlator 136 can determine if there an correlation between different sensor readings. For example, the correlator 136 can evaluate the aggregated data to determine whether there is a correlation between high hydrogen readings and temperature readings. The correlator 136 can apply a simple correlation (e.g., which measures a strength and direction of a liner relationship between two variables, such as a Pearson coefficient), a multiple correlation (e.g., which assesses a relationship between one dependent variable and two or more independent variables simultaneously, such as multiple regression analysis), and/or a partial correlation (e.g., which measures a relationship between two variables while controlling for an effect of one or more other variables). Thus, the correlator 136 can be configured to analyze the aggregated equipment data to determine whether the aggregated equipment data contains an anomaly indicative of a negative correlation between two more different attributes of the physical attributes and two or more different environmental conditions of the environmental conditions.

In some instances, the correlator 136 can identify outliers. The correlator 136 can identify one or more data points from the aggregated data that are outliers in the data points. The identified outliers from the aggregated equipment data can be excluded to provide filtered equipment data. In some examples, the filtered equipment data is used by the machine learning model 138 to provide the analytics data 130. By way of example, the correlator 136 can use an alarm (e.g., as shown in FIG. 9) for a sensor as a primary indicator of anomaly. For instance, a higher temperature reading with an alarm status for a sensor can be identified or flagged by the correlator 136 as an outlier. In some examples, the correlator 136 can apply statistical methods to identify readings that deviate (e.g., by an amount, percentage, threshold, or range) from a normal reading. This in some instances can involve comparing current readings against historical averages (e.g., one or more historical trends) or expected ranges. The correlator 136 can interpret outliers, by way of example, in context of a facility and/or room. For example, a high hydrogen reading (e.g., from a hydrogen sensor) in a battery room would be more concerning than in other areas as this can lead to damage and/or loss of life in some instances.

For example, with respect to FIG. 9, a high temperature (e.g., 80 Fahrenheit with an alarm “high”) at a room identified “UWIP5” which is an equipment room “EQ” can be determined by the correlator 136 an outlier if an average temperature in this room is lower (e.g., by a given amount or percentage) under similar conditions. A “2%” hydrogen reading with a “high” alarm for a room “UDHDCO” which is a battery room “BATT” can indicate a gas leak or a malfunctioning sensor, for example, if this reading is determined as an anomaly by the correlator 136 when compared to historical data.

By way of example, referred to as a given example, the aggregated equipment data identifies two type of sensors, a temperature and hydrogen sensor in various rooms of facilities. The correlator 136 can analyze a correlation between temperature and hydrogen readings across the facilities and/or rooms. For instance, under normal conditions, a higher temperature reading(s) can correlate with higher hydrogen reading(s) in certain rooms like a battery room. The correlator 136 can use the correlation to process the aggregated equipment data (or additional received aggregated equipment data) to identify any outliers. For example, if the correlator 136 identifies a time (or day) where in a facility in the battery room, the hydrogen reading increases by about 5% without a corresponding increase in temperature this can be flagged as an outlier, as it deviates from an expected pattern where the high hydrogen reading(s) accompanies the high temperature reading(s). In some examples, if the correlator 136 determines that in a facility at an equipment room where a temperature reading is high (e.g., about 95 F) but without triggering an alarm, which is different or deviates from the historical data where a high temperature typically set off alarms this can be flagged by the correlator 136 as an outlier. Thus, the correlator 136 can flag or identify data points in the aggregated equipment data that are outliers.

In some examples, the correlator 136 can output a set of coefficients that quantify a strength and direction of relationships between variables. This output reflects a general trend (or pattern) in the data, considering all data points, including outliers. In some examples, after outlier detection, the correlator module 136 can output the set of coefficients without data points that have deemed outlier data points. Thus, the correlator 136 can output data characterizing a trend or what is normal (a baseline trend) for the aggregated equipment data. Further received aggregate equipment data can be processed to determine a trend and the baseline trend can be compared by the correlator 136 to the baseline. In some examples, the baseline is a threshold. If there is difference between the trend and the baseline (e.g., by a given amount, range, or percentage), the correlator 136 can generate an alert 144 and/or reports for investigation of equipment and/or sensors. The reports can be rendered on output device, for example, as disclosed herein.

The alert 144 can be provided to the remediator 140 and used to cause an action. For example, when a high temperature alarm is active (e.g., see FIG. 9), the remediator 140 can initiate action to enable a backup air conditioning system. For example, the remediator 140 can initiate action (e.g., issue a command) to stop charging batteries for the equipment 104, and/or start up the backup ventilation in the room. The alert can be indicative of an anomaly for a given equipment, such as one of the equipment 104, as shown in FIG. 1. An anomaly can refer to a pattern or trend that deviates from an established or defined pattern (e.g., baseline trend). For example, if a temperature of an equipment rises while the pressure unexpectedly drops (e.g., contrary to their usual positive correlation), this could be identified as an anomaly. In some examples, after detecting such anomalies, the correlator 136 can either report these for further investigation or trigger automated systems for deeper analysis or immediate response.

By way of example, the correlator 136 can evaluate a relationship between a vibration frequency of the equipment 104 (e.g., a machine) and its operating temperature. Under normal conditions, these two variables have a defined correlation: as the operating temperature increases, vibration frequency slightly increases too. If the correlator 136 determines that the vibration frequency increases without a corresponding change in temperature, or vice versa, it would identify this as an anomaly and provide the alert 144 to the remediator 140. The anomaly can indicate a potential mechanical issue, such as a misalignment or wear and tear, prompting a maintenance check or further diagnostic measures. The remediator 140 can issue a remedial action 142 based on the alert 144, which can be provided to the equipment 104 to cause the equipment to shutdown, or enter a stand-by state, or another state in which a likelihood of harm or injury to the equipment 104 and/or life is mitigated or reduced. A type of alert that is provided by the correlator 136 can determine a type of remedial action that is taken by the remediator 140. The type of the remedial action 142 can can be based on a type of the equipment. The alert 144 can identify a type of equipment problem or issue for the equipment. For example, if the alert 144 is a potential mechanical issue that has a low likelihood of causing the equipment 104 to fail and/or harm to life, the remediator 140 can provide the equipment 104 with a control signal that cause the equipment 104 to enter into a reduced operating state rather than into a standby or shutdown state.

Thus, the remediator 140 can issue the remedial action 142 in response to the machine learning model 138 determining that the equipment 104 needs maintenance and/or the correlator determining that the equipment data contains the anomaly, which can indicative of that the equipment needs maintenance. The needed maintenance can be referred to in some instances as proactive maintenance. The remedial action 142 can include a command and the command can be provided to the equipment 104 to cause the equipment 104 to transition from an operational state into one of a shutdown state, standby state, or a reduced operational state. In some examples, the machine learning model 138 can be configured to provide one or or recommendations for one or more remedial actions, and the remediator 140 can be configured to selecting one of the remedial actions based on previous remedial actions and the provided one or more recommendations. The previous remedial actions can include replacing a specific part, performing a certain type of maintenance and adjusting operational parameters to avoid the failure. The previous remedial actions can be stored in the memory 112. In some examples, the memory 112 can include a remedial action database that stores different previous remedial actions for different equipment failures or conditions. The remediator 140 in these examples can select one of the remedial actions based on the remedial action database.

In some examples, the analyzer 128 can analyze the aggregated data to suggest the one or more actions for initiating or causing maintenance of the equipment 104. n. For example, the analyzer 128 can invoke the trained ML model 138 to determine the one or more actions. In some examples, the predictor 124 includes the remediator 140, as shown in FIG. 1. The remediator 140 can initiate a remedial action 142 to correct equipment failure without human interaction. The remediator 140 can receive the analytics data 130 with one or more recommendations for one one or remediation actions. A type of recommendation provided by the remediator 140 can be used on use-case scenario (e.g., equipment type). The remedial action 142 in some examples is a control command or signal (e.g., in some instances a software or application command) that cause the equipment 104 to take an action, such as shutdown to prevent harm or injury to the equipment 104 or life. Because the predictive maintenance engine 102 uses correlation and machine learning techniques for addressing equipment failure (or potential equipment failure), the engine 102 is able to more likely detect potential problems (or anomalies) with the equipment 104. The predictive maintenance engine 102 can be used to reduce downtime, extend equipment lifespan, increase safety, and provide cost savings through its dual use of correlation and machine learning. This synergistic approach enables the predictive maintenance engine 102 to be more effective and accurate in detecting potential equipment failures, for example, by providing more timely alerts, enabling proactive maintenance actions that prevent costly downtime and extend equipment life. By using both correlation analysis to understand direct relationships and machine learning to uncover complex patterns and adapt over time, the predictive maintenance engine 102 provides a sophisticated and dynamic approach to foreseeing equipment failures. This can result in more effective, data-driven maintenance strategies. In some examples, the remediator 140 can receive the alert 144 and the analytics data 130 from the analyzer 128. The remediator 140 can select a most aggressive remedial action as the remedial action 142 from the one or more remedial actions in response to receiving the alert 144 and the analytics data 130, as this can be indicative of immediate maintenance action is required for the equipment 104. The most aggressive remedial action can be a command or instruction that shutdowns the equipment 104, by contrast a less aggressive remedial action would be a command or instruction that causes the equipment 104 to enter a different operating system, but still continue to operate.

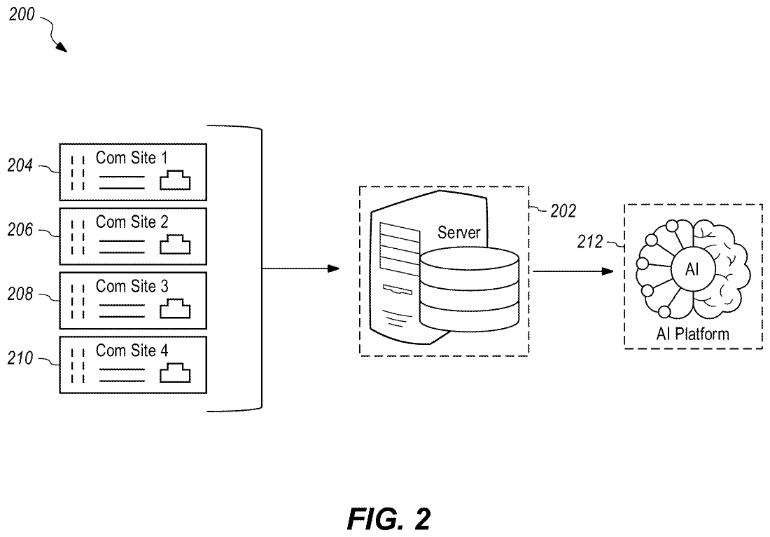

FIG. 2 is an example of a predictive maintenance system 200. The system 200 can include a server 202 and an artificial intelligence (AI) platform 212. The system 200 can receive equipment data from remote terminal units (RTUs) 204-210. In some examples, the equipment data is the equipment data 118, as shown in FIG. 1. Thus, reference can be made to one or more examples of FIG. 1 in the example of FIG. 2. In some instances, more or less RTU's can be used than as shown in the example of FIG. 2. The server 202 in some examples can correspond to the computing platform 108, as shown in FIG. 1.

The server 202 can be configured to receive the equipment data from each RTU of the RTUs 204-210. The RTUs 204-210 can be distributed across AITD sites in order to gather the needed data of facilities systems and can transmit the gathered through a network (e.g., wired and/or wireless network, including public and/or private networks) to the server 202, which in some instances can be referred to as a centralized server. The RTUs 204-210 can be equipped (e.g., connected or coupled) with one or more input devices, for example, but not limited to, spot temperature sensors, motion sensors, leak detection, power meters, visual detection, etc. Each input device can provide continuous reading for a specific parameter that's predefined within an RTU.

The server 202 can be configured to consolidate and integrate the gathered data (the equipment data) to an artificial intelligence (AI) platform 212 where the gathered data is processed according to one or more examples, as disclosed herein for failure prediction. In some examples, the data collector 122, as shown in FIG. 1, can be implemented on the server 202 and can be used for consolidating the gathered data. In further or alternative examples, the data aggregator 126, as shown in FIG. 1, can be implemented on the server 202 and can be used for integrating the gathered data after the data has been consolidated. In some examples, the AI platform 212 can correspond to the analyzer 128, as shown in FIG. 1. In some instances, the AI platform 212 includes the data aggregator 126. In some instances, the AI platform 212 is implemented on the server 202, or a different computing platform. In further or additional examples, the correlator 136, as shown in FIG. 1, can be implemented as part of the AI platform 212, and/or on the server 202.

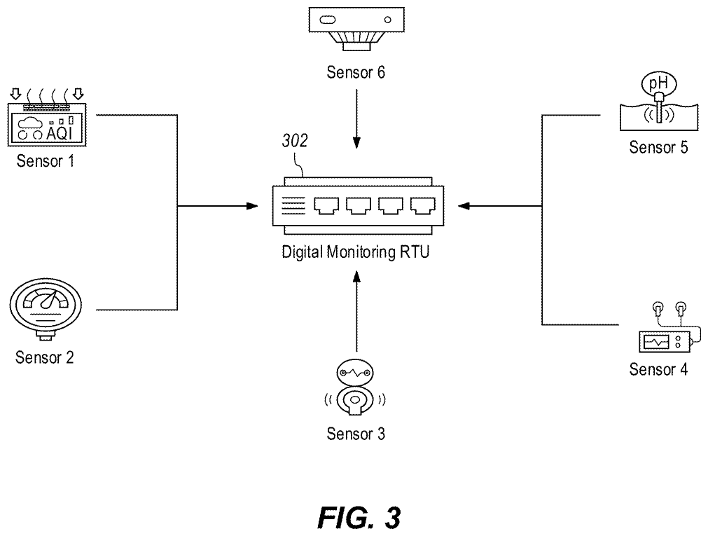

FIG. 3 is an example of a system 300 with am RTU 302. In some examples, the RTU 302 can correspond to one of the RTUs 204-210, as shown in FIG. 2. Thus, reference can be made to one or more examples of FIGS. 1-2 in the example of FIG. 3. The RTU 302 can be referred to as a digital monitoring RTU, as shown in FIG. 3. The RTU 302 can be configured to receive data from one or input device, which can include sensors, as shown in the example of FIG. 3. In the example of FIG. 3, the sensors are identified as “Sensor 1”, “Sensor 2”, “Sensor 3”, “Sensor 4”, and “Sensor 5”. One or more of the sensors can be configured to measure a physical attribute or condition of equipment (or multiple equipment) or an environment in which the equipment operates, such as one of the equipment 104, as shown in FIG. 1. The RTU 302 can provide the received data from the sensors as the equipment data 118, as shown in FIG. 1 for further processing according to one or more examples, as disclosed herein.

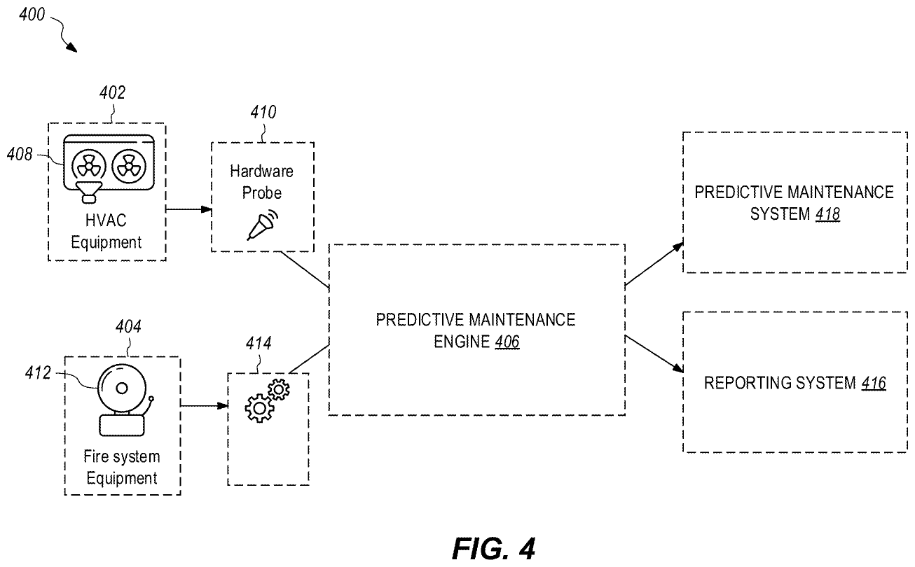

FIG. 4 is an example of a facility 400 configured with a heating, ventilation, and air condition (HVAC) system 402 and fire system 404 that uses predictive maintenance according to one or more examples as disclosed herein. In some examples, the facility 400 is the facility 106, as shown in FIG. 1. Thus, reference can be made to one or more examples of FIGS. 1-3 in the example of FIG. 4. For clarity and brevity purposes, not all components of the HVAC system 402 and the fire system 404 are shown in the example of FIG. 4. The facility 400 can be configured with a predictive maintenance engine 406, which can correspond to the predictive maintenance system 100, as shown in FIG. 1, or the predictive maintenance system 200, as shown in FIG. 2, in some examples. In some examples, the HVAC system 402 can be implemented at a facility, such as the facility 106, as shown in FIG. 1.

The HVAC system 402 can include HVAC equipment 408, in some instances, HVAC equipment, such as disclosed herein. In some examples, the HVAC equipment 408 can correspond to one of the equipment 104, as shown in FIG. 1. A hardware probe (HP) 410 can be used to collect metric and data from the HVAC equipment 408. In some examples, the HP 410 can correspond to one of the data sources 114-116, as shown in FIG. 1. The HP 410 can correspond to a device that can be configured to analyze and collect metric and data from the HVAC equipment 408. In some examples, the HP 410 can be a dedicated device for a specific technology or equipment and can be deployed in a harsh environment. The HP 410 can provide equipment data to the predictive maintenance engine 406, which can be similar to one of the equipment data 118-120, as shown in FIG. 1, in some examples.

The fire system 404 can include fire equipment 412, in some instances, fire equipment, such as disclosed herein. Example fire equipment can include, but not limited to, fire detectors, alarm systems, fire suppression equipment, emergency lighting and exit signs, fire control panels, communication systems, etc. A probe 414 can be used to collect or monitor parameters (as data) of the fire equipment 412 and provide that data as one of the equipment data 118-120, to the predictive maintenance engine 406. In some examples, the probe 414 can be implemented on a server or a computing platform, such as disclosed herein. The probe 414 can be connected (or be in communication) with the fire equipment 412. The probe 414 can be configured to collect real-time data from devices such as smoke detectors, heat sensors, and gas sensors, as a non-limiting example. In some examples, the probe 414 can correspond to one of the data collectors 122, as shown in FIG. 1. Using communication protocols relevant to fire systems, the probe 414 can be configured to interface with control systems to receive and send information. This could involve protocols specific to fire safety equipment. While examples are presented herein in which the probe 414 is used with respect to the fire equipment 412, in other examples, a SP can be used to collect or monitor parameters of the HVAC equipment 408. In some examples, the HP 410 can be used to collect metric and data from the fire equipment 412 and provide that data as one of the equipment data 118-120, to the predictive maintenance engine 406.

SPs can be designed with flexible programming capabilities, allowing them to be tailored to specific monitoring needs. This means SPs can be programmed or configured to collect a wide range of data points, depending on what is relevant for the equipment being monitored. A SP can have a modular design, meaning different functional modules can be added, removed, or modified. This allows for a high degree of customization in terms of what data is collected and how it's processed. In some examples, a SP can support scripting languages or configuration files. Through these, users can define specific parameters, set thresholds, and specify which metrics to collect, making the probe suitable for various applications. In some examples, the SP can be integrated with existing systems.

In some examples, the probe 414 can interact with equipment (as disclosed herein) through industrial communication protocols, for example, MODBUS or BACNET. These protocols are standard in industrial environments and can be used to allow the probe 414 to communicate with a variety of industrial control systems, such as PLCs (Programmable Logic Controllers) or HVAC systems, etc. The probe 414 can be configured to read data from these systems, like temperature readings, operational status, or error messages, and can also send commands or set parameters based on the collected data. In IT examples, the probe 414 can be configured using application program interfaces (APIs), for example, simple object access protocol (SOAP) or RESTful APIs to interact with software systems and/or servers. Through these APIs, the probe 414 can be configured to collect data such as system performance metrics, logs, or status updates. The probe 414 can be configured in some instances to perform actions like initiating processes or updating configurations on the software systems that the probe 414 can be configured to monitor.

The predictive maintenance engine 406 can be configured to predict equipment failure (e.g., provide the analytics data 130, as shown in FIG. 1) in a same or similar manner as the predictive maintenance engine 102 or the system 200, as disclosed herein. For example, each data collector 122 (in some instances referred to as a data collection agent (DCA)) can collect data from various data sources, such as the HVAC equipment 408, the fire equipment 412, for example. The data collector 122 can in some instances be implemented as a combination of hardware and/or software. The data collector 122 can act as an intermediary between various facility equipment and a central processing module, such as the predictor 124, as shown in FIG. 1. The data collector 122 can collect data from different sources and send the collected data to the predictor 124, as disclosed herein, which can use the collected data (the equipment data 118) to make a failure prediction and provides suggestions (or actions) for initiating maintenance, which can be referred to as predictive maintenance as its not scheduled maintenance.

In some examples, the data collector 122 can receive the equipment data 118 from the data source 114. In some instances, the data collector 122 and the data source 114 can communicate over a dedicated (or private) network, which can correspond to the network 120, as shown in FIG. 1. Thus, the data collector 122 and the data source 114 can communicate over a separate network that is independent of a primary network or system used at the facility 400. Because the data source 114 uses a dedicated network to communicate with the data collector 122, and the data source 114 could be implemented as a probe (or sensor), the data source 114 can be referred to as an out of band probe. An out of band probe is a hardware device that collects data independently of a main operational network of facility equipment and thus uses an out-of-band network. This means the out of band probe do not interfere with or rely on the primary network traffic for data collection, which adds an extra layer of security and reliability. A main operational network is a primary network that a facility's equipment uses for its regular operations. For example, in a data center, this would be the network used for data processing, storage, and online transactions. The out-of-band network is a secondary, separate network used exclusively for monitoring and management purposes. The out-of-band probes can connect to this network to transmit data to the data collector 122.

For instance, if the primary network fails or is compromised, out-of-band probes can still function and collect data. This is particularly important for critical systems like HVAC (Heating, Ventilation, and Air Conditioning) or fire safety systems, where uninterrupted monitoring is essential. The DCA, through its out-of-band probes, collects various types of data from facility equipment such as HVAC systems, fire safety systems, etc. This data can include, but not limited to, status metrics (e.g., information about the operational status of the equipment. For example, whether a fire alarm is active or inactive, or if an HVAC unit is on or off) and performance metrics (e.g., data that indicates how well the equipment is functioning. This can include, for example, temperature readings from HVAC systems, smoke or heat levels from fire systems, and other performance-related data.). By using out-of-band probes, the DCA ensures continuous and secure data collection, which is critical for effective facility management and preventive maintenance.

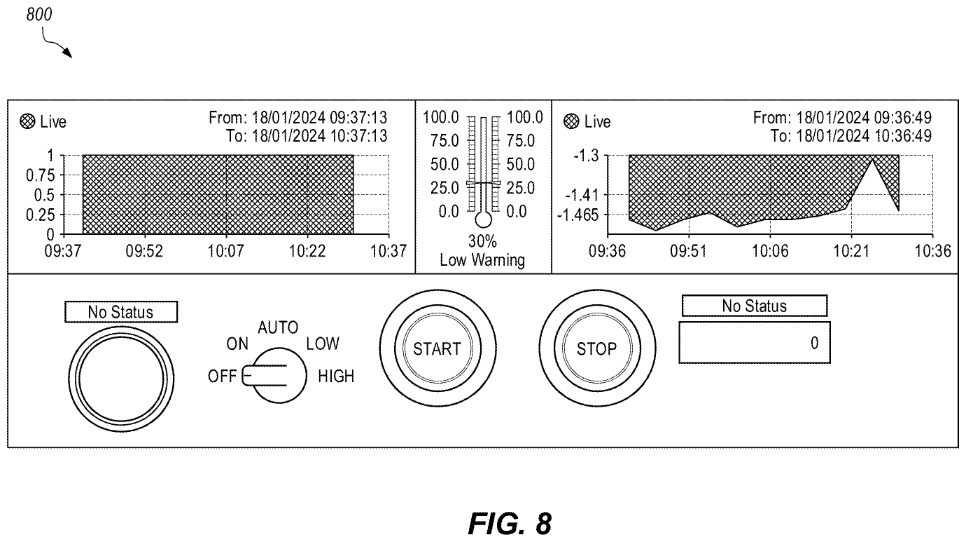

In some examples, the predictive maintenance engine 406 can communicate with a reporting system (or platform) 416. The reporting system 416 can be implemented on a computing platform, such as disclosed herein and thus in some examples can be implemented as machine-readable instructions that can be executed on the computing platform. The reporting system 416 can include a business intelligent (BI) module, a dashboard (e.g., that can be rendered on a display), user and administrator modules. The BI module utilizes the analytics data provided by the predictive maintenance engine 406 to produce executive and working level dashboards. FIG. 8 is an example of a graphical user interface (GUI) 800 that can be generated by the BI module of the reporting system 416. The GUI 800 is representative of a monitoring dashboard and provides a summary of equipment status, which provides an overall health of the monitored environment and scheduled or ongoing preventive maintenance. For example, the GUI 800 can represent real-time operational parameters for one or more facilities. The GUI 800 can enable operations teams to oversee a status of the facility equipment and future maintenance. In some examples, the BI module of the reporting system 416 can provide a working level customized dashboard (as the GUI 800) with narrowing capabilities to provide a more detailed analysis for different operational groups.

In some examples, the predictive maintenance engine 406 can communicate with and a preventative maintenance system (or platform) 418. In some examples, the predictive maintenance engine has a bidirectional interface that enables the predictive maintenance engine 406 to send and receive data from the preventative maintenance system 418, which can also have a bidirectional interface. Data can be synchronized between the predictive maintenance engine 406 and the preventative maintenance system 418 through use of the bidirectional interface. The preventative maintenance system 418 can be implemented on a computing platform, such as disclosed herein and thus in some examples can be implemented as machine-readable instructions that can be executed on the computing platform. In some examples, the preventative maintenance system 418 can be software that can be used for managing preventative maintenance tasks, which can be provided based on or from the analytics data 130. Example systems of the preventative maintenance system 418 can include systems like SAP, enterprise resource planning (ESP) software. The software can be used to organize, manage, and schedule maintenance activities (or tasks) before a problem occurs based on the analytics data 130.

In some examples, the predictive maintenance engine 406 using the bidirectional interface can initiate (e.g., automatically) maintenance orders. For example, the predictive maintenance engine 406 can cause the preventive maintenance system 418 to schedule maintenance tasks, dispatch personnel (e.g., by causing the preventative maintenance system 418 to send an alert, an email, message, etc. to a device used by personnel), or cause the preventive maintenance system 418 to order parts for replacement, or alert personnel to order the parts. In additional or alternative examples, the predictive maintenance engine 406 can retrieve (or fetch) information about a status of maintenance tasks that are completed, in progress, or scheduled. The predictive maintenance engine 406 can apply its outputs to alter these maintenance tasks status. For example, an “X” work order is scheduled for a particular data the predictive maintenance engine 406 can cause it to be reschedule to a different date.

Thus, in some examples, the predictive maintenance engine 406 can be integrated into or communicate with a preventive maintenance platform and utilize machine learning techniques to analyze equipment data logs for equipment maintenance prediction. Consequently, recommendations can be triggered by comparing a visibility of a periodic maintenance cycle with actual parameters of the equipment to either accelerate or decelerate a PM cycle. As a result, critical equipment life cycle can be increased, and required site visits (e.g., to the facility, such as the facility 400) can be minimized which contributes to cost saving and time optimization. The predictive maintenance engine 406 can be used to enhance real-time monitoring and use machine learning techniques to maintain remote devices (or equipment) and increase equipment life-cycle.

In some examples, the predictive maintenance engine 102 can be referred to as an analytical artificial intelligence (AIE) engine. The AIE engine can have a number of interfaces (e.g., bidirectional interfaces) for interfacing with the data collector 122, the reporting system 416, and the predictive maintenance system 418. The AIE engine can in some instances include four (4) modules: a correlator, an aggregation module, an analytics module, and a remedian monitoring module. The aggregation module can be implemented as the data aggregator 126, the analytics module can be implemented as the analyzer 128, the correlation module can be implemented as the correlator 136, and the remediation monitoring module can be implemented as the remediator 140, as shown in FIG. 1, in some instances. In some examples, the aggregation module gathers data (e.g., the equipment data 118) and the correlation module can correlate the aggregated data against a historical trend. The analytics module can analyze the aggregated data and predict a possibility of equipment failures and suggests a need for action to initiate predictive maintenance. The aggregation module collects data from all data collection agents. The correlation module correlates the analysis results received from the analysis module and looks for consistency and draw the big picture. The analytics module can analyze the aggregated data from the aggregation module, compare it to the trends and determine the appropriate action and suggestions.

Currently, only limited equipment is fully monitored, where a portion is either partially monitored (meaning that we can only know an on/off status) or totally unmonitored. The system 100 allows for full monitoring with real-time data of all equipment and components utilizing a digital monitoring device. The predictive maintenance engine 406 can be configured to receive analog alarms (e.g., have the capability to connect any dry-contact facilities equipment and provide a high-level status (On-Off)), digital alarms (e.g., have the capability to connect via Ethernet cable or any alternative source that can provide a digital reading for the connected device, for example, HVAC can provide us with the Unit temperature in C/F), receive real-time data (e.g., have the capability to provide a real-time date along with a log that can support and enable AIOps smart use cases), remote adjustment (e.g., have the capability to remotely control or adjust any device, for example, remotely turn on the backup power generator in case of emergency, for example, adjust an HVAC temperature unit), provide smart analytics (e.g., support D&IT AIOps program and use cases, support AITD to move from preventive maintenance stage to predictive maintenance level, so it can predict any failure prior it happens, meet security requirements (e.g., meet security standards and be clear from any vulnerabilities, e.g., a server and data must be in-primes not cloud), integrate with existing system(s) (e.g., have the capability to integrate with an existing system via a communication system), and allow for integration with future systems (e.g., have the capability to be integrated with any future system by meeting the common protocols and standards).

By using the predictive maintenance engine 406, IT productivity can be improved in some examples. For example, by automating the analysis, centralization, and integration of logs from different sources, the predictive maintenance engine 406 is able to substantially reduce the number of hours needed to resolve incidents, making IT productive with the same resources and reducing MTTR. In some examples, by using the predictive maintenance engine 406 outages can be prevented. For example, the predictive maintenance engine 406 can use a knowledge base that allows for automating root-cause analysis, thus reducing a number of P1 incidents. Thus, the predictive maintenance engine 406 can be used to support teams to handle most application and infrastructure issues without escalation to DevOps or R&D. Furthermore, the predictive maintenance engine 406 can be used to increase output of employees. For example, by using the predictive maintenance engine 406 to support applications, infrastructure and network monitoring empowers IT to deliver growth and stability to the business. Cost saving can be realized by using the predictive maintenance engine 406 as organizations can reduce a use of multiple on premise solutions and associated maintenance while also reducing outsourcing costs.

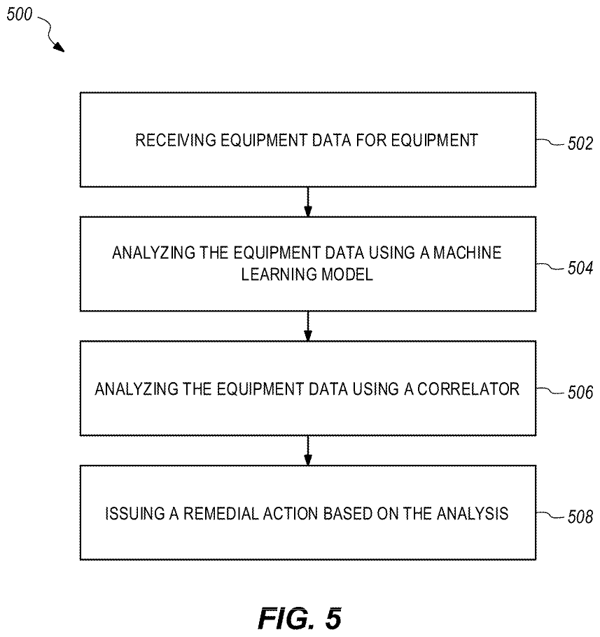

In view of the foregoing structural and functional features described above, an example method will be better appreciated with reference to FIG. 5. While, for purposes of simplicity of explanation, the example method of FIG. 5 are shown and described as executing serially, it is to be understood and appreciated that the present example is not limited by the illustrated order, as some actions could in other examples occur in different orders, multiple times and/or concurrently from that shown and disclosed herein. Moreover, it is not necessary that all described actions be performed to implement the method.

FIG. 5 is an example of a method 500 for predictive maintenance of equipment, such as the equipment 104, as shown in FIG. 1. The method 500 can be implemented by the predictive maintenance engine 102, as shown in FIG. 1. Thus, reference can be made to one or more examples of FIGS. 1-4 in the example of FIG. 5. The method 500 can begin at 502 by receiving equipment data (e.g., the equipment data 118, as shown in FIG. 1) for equipment (e.g., the equipment 104, as shown in FIG. 1) that can include data points relating to physical attributes of the equipment or environmental conditions for the equipment. At 504, analyzing the equipment data using an ML model (e.g., the ML model 138, as shown in FIG. 1) to determine whether the equipment needs maintenance. At 506, analyzing using a correlator (e.g., the correlator 136, as shown in FIG. 1) the equipment data to determine whether the equipment data contains an anomaly indicative of a negative correlation between two more different attributes of the physical attributes and two or more different environmental conditions of the environmental conditions. At 508, issuing a remedial action (e.g., the remedial action 142, as shown in FIG. 1) in response to the ML model determining that the equipment needs maintenance and/or the correlator determining that the equipment data contains the anomaly.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

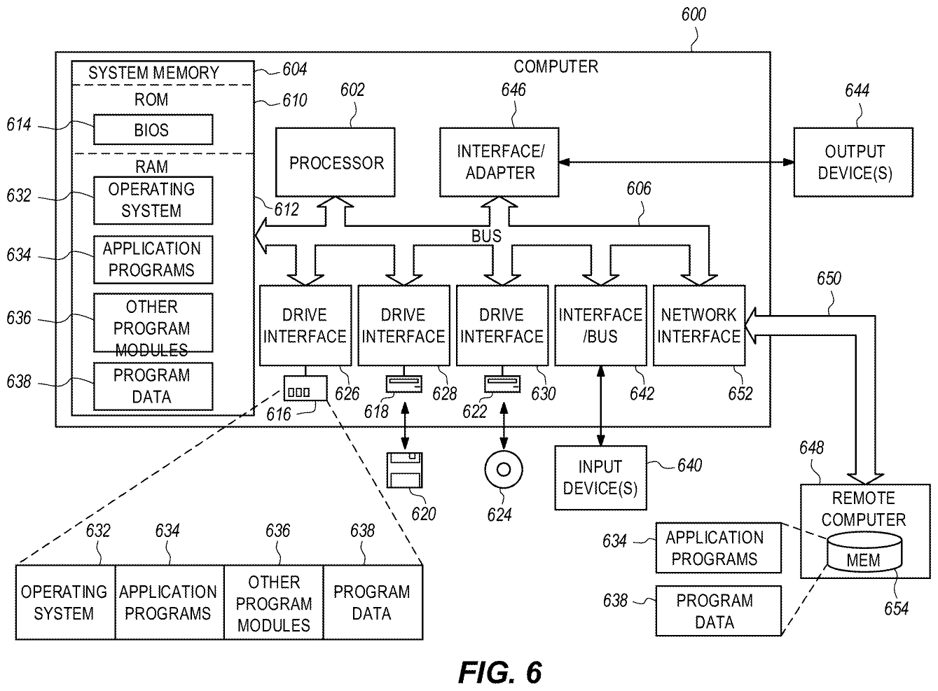

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 6. Thus, reference can be made to one or more examples of FIGS. 1-5 in the example of FIG. 6.

In this regard, FIG. 6 illustrates one example of a computer system 600 that can be employed to execute one or more embodiments of the present disclosure. Computer system 600 can be implemented on one or more general purpose networked computer systems, embedded computer systems, routers, switches, server devices, client devices, various intermediate devices/nodes or standalone computer systems. Additionally, computer system 600 can be implemented on various mobile clients such as, for example, a personal digital assistant (PDA), laptop computer, pager, and the like, provided it includes sufficient processing capabilities.

Computer system 600 includes processing unit 602, system memory 604, and system bus 606 that couples various system components, including the system memory 604, to processing unit 602. Dual microprocessors and other multi-processor architectures also can be used as processing unit 602. System bus 606 may be any of several types of bus structure including a memory bus or memory controller, a peripheral bus, and a local bus using any of a variety of bus architectures. System memory 604 includes read only memory (ROM) 610 and random access memory (RAM) 612. A basic input/output system (BIOS) 614 can reside in ROM 612 containing the basic routines that help to transfer information among elements within computer system 600.

Computer system 600 can include a hard disk drive 616, magnetic disk drive 618, e.g., to read from or write to removable disk 620, and an optical disk drive 622, e.g., for reading CD-ROM disk 624 or to read from or write to other optical media. Hard disk drive 616, magnetic disk drive 618, and optical disk drive 622 are connected to system bus 606 by a hard disk drive interface 626, a magnetic disk drive interface 628, and an optical drive interface 630, respectively. The drives and associated computer-readable media provide nonvolatile storage of data, data structures, and computer-executable instructions for computer system 600. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and disclosed herein. A number of program modules may be stored in drives and RAM 610, including operating system 632, one or more application programs 634, other program modules 636, and program data 638. In some examples, the application programs 634 can include one or more modules (or block diagrams), or systems, as shown and disclosed herein. Thus, in some examples, the application programs 634 can include the predictive maintenance engine 102 (or one or more of its modules, as shown in FIG. 1.

A user may enter commands and information into computer system 600 through one or more input devices 640, such as a pointing device (e.g., a mouse, touch screen), keyboard, microphone, joystick, game pad, scanner, and the like. These and other input devices are often connected to processing unit 602 through a corresponding port interface 642 that is coupled to the system bus, but may be connected by other interfaces, such as a parallel port, serial port, or universal serial bus (USB). One or more output devices 644 (e.g., display, a monitor, printer, projector, or other type of displaying device) is also connected to system bus 606 via interface 646, such as a video adapter.

Computer system 600 may operate in a networked environment using logical connections to one or more remote computers, such as remote computer 648. Remote computer 648 may be a workstation, computer system, router, peer device, or other common network node, and typically includes many or all the elements described relative to computer system 600. The logical connections, schematically indicated at 650, can include a local area network (LAN) and a wide area network (WAN). When used in a LAN networking environment, computer system 600 can be connected to the local network through a network interface or adapter 652. When used in a WAN networking environment, computer system 600 can include a modem, or can be connected to a communications server on the LAN. The modem, which may be internal or external, can be connected to system bus 606 via an appropriate port interface. In a networked environment, application programs 634 or program data 638 depicted relative to computer system 600, or portions thereof, may be stored in a remote memory storage device 654.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

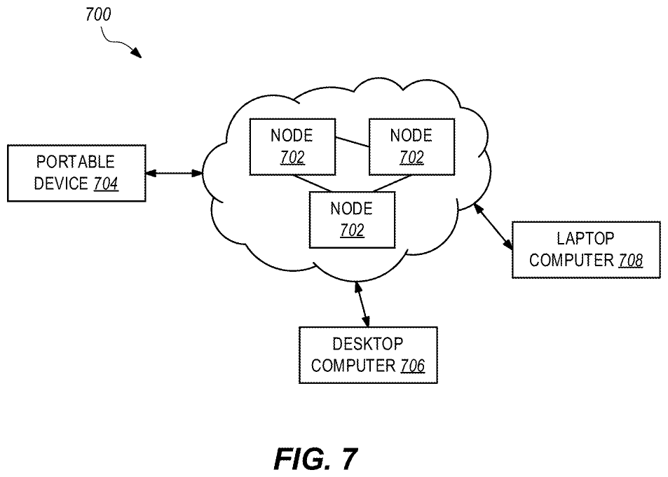

FIG. 7 is an example of a cloud computing environment 700 that can be used for implementing one or more modules and/or systems in accordance with one or more examples, as disclosed herein. Thus, reference can be made to one or more examples of FIGS. 1-6 in the example of FIG. 7. As shown, cloud computing environment 700 can include one or more cloud computing nodes 702 with which local computing devices used by cloud consumers (or users), such as, for example, personal digital assistant (PDA), cellular, or portable device 704, a desktop computer 706, and/or a laptop computer 708, may communicate. The computing nodes 702 can communicate with one another. In some examples, the computing nodes 702 can be grouped (not shown) physically or virtually, in one or more networks, such as Private, Community, Public, or Hybrid clouds, or a combination thereof. This allows the cloud computing environment 700 to offer infrastructure, platforms and/or software as services for which a cloud consumer does not need to maintain resources on a local computing device. The devices 704-708, as shown in FIG. 7, are intended to be illustrative and that computing nodes 702 and cloud computing environment 700 can communicate with any type of computerized device over any type of network and/or network addressable connection (e.g., using a web browser). In some examples, the one or more computing nodes 702 are used for implementing one or more examples disclosed herein relating to root-source identification. Thus, in some examples, the one or more computing nodes can be used to implement modules, platforms, and/or systems, as disclosed herein.

In some examples, the cloud computing environment 700 can provide one or more functional abstraction layers. It is to be understood that the cloud computing environment 700 need not provide all of the one or more functional abstraction layers (and corresponding functions and/or components), as disclosed herein. For example, the cloud computing environment 700 can provide a hardware and software layer that can include hardware and software components. Examples of hardware components include: mainframes; RISC (Reduced Instruction Set Computer) architecture based servers; servers; blade servers; storage devices; and networks and networking components. In some embodiments, software components include network application server software and database software.

In some examples, the cloud computing environment 700 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 700 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 700, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 700 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, the cloud computing environment 700 can provide a workloads layer that provides examples of functionality for which the cloud computing environment 700 may be utilized. Examples of workloads and functions which may be provided from this layer include: mapping and navigation; software development and lifecycle management; virtual classroom education delivery; data analytics processing; and transaction processing. Various embodiments of the present disclosure can utilize the cloud computing environment 700.

### ADDITIONAL EMBODIMENTS

Embodiments disclosed herein include:

A. A method comprising: receiving equipment data for equipment comprising data points relating to physical attributes of the equipment or environmental conditions for the equipment; analyzing the equipment data using a ML model to determine whether the equipment needs maintenance; analyzing using a correlator the equipment data to determine whether the equipment data contains an anomaly indicative of a negative correlation between two more different attributes of the physical attributes and two or more different environmental conditions of the environmental conditions; and issuing a remedial action in response to the ML model determining that the equipment needs maintenance and/or the correlator determining that the equipment data contains the anomaly.

B. A system comprising: a predictive maintenance engine comprising: a data aggregator configured to aggregate equipment data from one or more data sources to provide aggregated equipment data, the equipment data comprising data points relating to physical attributes of the equipment or environmental conditions for the equipment; a correlator configured to analyze the aggregated equipment data to determine whether the aggregated equipment data contains an anomaly indicative of a negative correlation between two more different attributes of the physical attributes and two or more different environmental conditions of the environmental conditions; an analyzer comprising a ML model configured to analyze the aggregated equipment data to determine whether the equipment needs maintenance; and a remediator configured to issuing a remedial action in response to the ML model determining that the equipment needs maintenance and/or the correlator determining that the equipment data contains the anomaly.

C. A system comprising: one or more computing platforms configured to: receive equipment data for equipment comprising data points relating to physical attributes of the equipment or environmental conditions for the equipment; analyze the equipment data using a ML model to determine whether the equipment needs maintenance; analyze using a correlator the equipment data to determine whether the equipment data contains an anomaly indicative of a negative correlation between two more different attributes of the physical attributes and two or more different environmental conditions of the environmental conditions; and issue a remedial action in response to the ML model determining that the equipment needs maintenance and the correlator determining that the equipment data contains the anomaly.

Each of embodiments A through C may have one or more of the following additional elements in any combination: Element 1: generating a command and providing the command to the equipment to cause the equipment to transition from an operational state into one of a shutdown state, standby state, or a reduced operational state; Element 2: wherein the equipment data is first equipment data and second equipment data, the method further comprising aggregating the equipment data to provide the equipment data in predefined format; Element 3: training the ML model based on training data representing a variance between real-time equipment data and predefined equipment data; Element 4: identifying one or more data points that are outliers in the data points; and excluding the identified outliers from the equipment data to provide filtered equipment data; Element 5: analyzing the filtered equipment data to determine whether the filtered equipment data contains the anomaly; Element 6: generating an alert in response to determining that the equipment data contains the anomaly; Element 7: wherein the remedial action is issued based on the alert; Element 8: wherein a type of the remedial action issued is based on a type of the equipment; Element 9: wherein the ML model is configured to provide one or or recommendations for one or more remedial actions, and the method further comprising selecting one of the remedial actions based on previous remedial actions and the provided one or more recommendations; Element 10: wherein the previous remedial actions comprises replacing a specific part, performing a certain type of maintenance and adjusting operational parameters to avoid the failure; Element 11: wherein the remediator is configured to generate a command as the remedial action and provide the command to the equipment to cause the equipment to transition from an operational state into one of a shutdown state, standby state, or a reduced operational state; Element 12: a ML training algorithm configured to train the ML model based on training data representing a variance between real-time equipment data and predefined equipment data; Element 13: wherein the correlator is further configured to: identify one or more data points that are outliers in the data points; exclude the identified outliers from the aggregated equipment data to provide filtered equipment data; and analyze the filtered equipment data to determine whether the filtered equipment data contains the anomaly; Element 14: wherein a type of the remedial action issued is based on a type of the equipment; Element 15: wherein the ML model is configured to provide one or or recommendations for one or more remedial actions, and the remediator is further configured to select one of the remedial actions based on previous remedial actions and the provided one or more recommendations; Element 16: wherein the previous remedial actions comprises replacing a specific part, performing a certain type of maintenance and adjusting operational parameters to avoid the failure; and Element 17: wherein the ML model is configured to provide one or or recommendations for one or more remedial actions, and the method further comprising selecting one of the remedial actions based on previous remedial actions and the provided one or more recommendations, and the the previous remedial actions comprises replacing a specific part, performing a certain type of maintenance and adjusting operational parameters to avoid the failure.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 5-10% of the indicated number.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

The invention claimed is:

1. A method comprising:
receiving equipment data for equipment comprising data points relating to physical attributes of the equipment or environmental conditions for the equipment;
analyzing the equipment data using a machine learning (ML) model to determine whether the equipment needs maintenance;
analyzing using a correlator the equipment data to determine whether the equipment data contains an anomaly indicative of a negative correlation between two more different attributes of the physical attributes and two or more different environmental conditions of the environmental conditions; and
issuing a remedial action in response to the ML model determining that the equipment needs maintenance and/or the correlator determining that the equipment data contains the anomaly.

2. The method of claim 1, wherein said issuing the remedial action comprises generating a command and providing the command to the equipment to cause the equipment to transition from an operational state into one of a shutdown state, standby state, or a reduced operational state.

3. The method of claim 1, wherein the equipment data is first equipment data and second equipment data, the method further comprising aggregating the equipment data to provide the equipment data in predefined format.

4. The method of claim 1, further comprising training the ML model based on training data representing a variance between real-time equipment data and predefined equipment data.

5. The method of claim 1, further comprising:
identifying one or more data points that are outliers in the data points; and
excluding the identified outliers from the equipment data to provide filtered equipment data.

6. The method of claim 5, further comprising wherein the analyzing using the correlator comprises analyzing the filtered equipment data to determine whether the filtered equipment data contains the anomaly.

7. The method of claim 1, further comprising generating an alert in response to determining that the equipment data contains the anomaly.

8. The method of claim 7, wherein the remedial action is issued based on the alert.

9. The method of claim 1, wherein a type of the remedial action issued is based on a type of the equipment.

10. The method of claim 1, wherein the ML model is configured to provide one or or recommendations for one or more remedial actions, and the method further comprising selecting one of the remedial actions based on previous remedial actions and the provided one or more recommendations.

11. The method of claim 10, wherein the previous remedial actions comprises replacing a specific part, performing a certain type of maintenance and adjusting operational parameters to avoid the failure.

12. A system comprising:
a predictive maintenance engine comprising:
a data aggregator configured to aggregate equipment data from one or more data sources to provide aggregated equipment data, the equipment data comprising data points relating to physical attributes of the equipment or environmental conditions for the equipment;
a correlator configured to analyze the aggregated equipment data to determine whether the aggregated equipment data contains an anomaly indicative of a negative correlation between two more different attributes of the physical attributes and two or more different environmental conditions of the environmental conditions;
an analyzer comprising a machine learning (ML) model configured to analyze the aggregated equipment data to determine whether the equipment needs maintenance; and
a remediator configured to issuing a remedial action in response to the ML model determining that the equipment needs maintenance and/or the correlator determining that the equipment data contains the anomaly.

13. The system of claim 12, wherein the remediator is configured to generate a command as the remedial action and provide the command to the equipment to cause the equipment to transition from an operational state into one of a shutdown state, standby state, or a reduced operational state.

14. The system of claim 12, further comprising a ML training algorithm configured to train the ML model based on training data representing a variance between real-time equipment data and predefined equipment data.

15. The system of claim 12, wherein the correlator is further configured to:
identify one or more data points that are outliers in the data points;
exclude the identified outliers from the aggregated equipment data to provide filtered equipment data; and
analyze the filtered equipment data to determine whether the filtered equipment data contains the anomaly.

16. The system of claim 12, wherein a type of the remedial action issued is based on a type of the equipment.

17. The system of claim 12, wherein the ML model is configured to provide one or or recommendations for one or more remedial actions, and the remediator is further configured to select one of the remedial actions based on previous remedial actions and the provided one or more recommendations.

18. The system of claim 17, wherein the previous remedial actions comprises replacing a specific part, performing a certain type of maintenance and adjusting operational parameters to avoid the failure.

19. A system comprising
one or more computing platforms configured to:
receive equipment data for equipment comprising data points relating to physical attributes of the equipment or environmental conditions for the equipment;
analyze the equipment data using a machine learning (ML) model to determine whether the equipment needs maintenance;
analyze using a correlator the equipment data to determine whether the equipment data contains an anomaly indicative of a negative correlation between two more different attributes of the physical attributes and two or more different environmental conditions of the environmental conditions; and
issue a remedial action in response to the ML model determining that the equipment needs maintenance and the correlator determining that the equipment data contains the anomaly.

20. The system of claim 19, wherein the ML model is configured to provide one or or recommendations for one or more remedial actions, and the method further comprising selecting one of the remedial actions based on previous remedial actions and the provided one or more recommendations, and the the previous remedial actions comprises replacing a specific part, performing a certain type of maintenance and adjusting operational parameters to avoid the failure.
